(19) United States
(12) Patent Application Publication
(10) Pub. No.: US 2007/0255874 A1
(43) Pub. Date: Nov. 1, 2007

(54) System and method for target device access arbitration using queuing devices

(76) Inventor: Kevin F. Jennings, Novi, MI (US)

Correspondence Address: UNISYS CORPORATION, UNISYS WAY, MAIL STATION: E8-114, BLUE BELL, PA, 19424, US

(21) Appl. No.: 11/788,724

(22) Filed: Apr. 20, 2007

Related U.S. Application Data
(60) Provisional application No. 60/795,862, filed on Apr. 28, 2006.

(51) Int. Cl. G06F 13/00; G06F 13/36

(52) U.S. Cl. 710/113; 710/110

(57) ABSTRACT

A system and method for slave-side arbitration includes a plurality of master devices, a target device, and an arbitrator for arbitrating access to the target device by the master devices. Queuing devices, such as FIFO buffers, are respectively associated with master devices and communicate information regarding retained target device access requests to the arbitrator. The information may be communicated to the arbitrator by sending it to the arbitrator, or may be provided as status information that is accessed by the arbitrator. The arbitrator uses an arbitration scheme and information regarding retained transaction requests to determine which master device should be granted access to the target device. The arbitration system and method can be used in an integrated circuit with multiple embedded processors, and can be implemented in a document processing system to improve overall system performance over conventional slave-side arbitration schemes.

### CROSS REFERENCE TO RELATED APPLICATIONS

This application claims the benefit under 35 U.S.C. § 119 of U.S. Provisional Patent Application Ser. No. 60/795,862, entitled IMPROVED PERFORMANCE OF SLAVE-SIDE ARBITRATION USING FIFO BUFFERS, filed on Apr. 28, 2006, the entire contents of which are hereby incorporated by reference.

### BACKGROUND OF THE INVENTION

1. Field of the Invention

This invention relates to the field of data communications. More specifically, it relates to arbitration in a system having a plurality of master devices desiring access to at least one shared target device through the use of first in, first out (FIFO) buffer devices.

2. Description of the Related Art

Data transfer may refer to the transmission or exchange of data from one location to another. In a computer or other similar processing system environment, the term encompasses the transmission or exchange of data internal to the computer or processing system as well as to peripheral devices or components connected externally thereto. In addition, data transfer may include the transmission or exchange of data within components on an integrated circuit or chip.

In general, data transfer is carried out over some type of communications pathway or bus. For example, in the case of data transferred outside of the computer or other processing system, serial buses such as USB, IEEE 1394 (FireWire), and Fibre Channel, and parallel buses such as ATA (IDE), PCMCIA, and SCSI may be used. Within a computer, known serial buses such as PCIe and InfiniBand and parallel buses such as PCI and EISA may be used. For data communications within integrated circuits such as field programmable field arrays (FPGA), application specific integrated circuits (ASIC), and system-on-chip (SoC), where high speed data transfers are required, the Advanced High-performance Bus (AHB) architecture may be used. Of course, it will be appreciated that any of the many other bus implementations may be used.

In many conventional systems, in order for data transfer to be affected, a first device or component, nominally known as an “initiator” or “master,” initiates a request or transaction, which will be carried across the bus to a device or component that is the recipient of that request or transaction, nominally known as a “target.” Any component or device that is capable of initiating read and write operations by providing control information including address data is referred to herein as a “master” device or component. Similarly, any component or device that responds to read or write operations by transmitting or transferring back to the master, information that relates to the requested read or write operation, is referred to herein as a “target” device or component. It will be further appreciated that in certain systems, a device or component has the ability to be both a “master” and a “target,” but generally is so at different times and to carry out different transactions. In these instances, again, the “master” is the device that initiates a particular read or write transaction, while a “target” is a device or component that responds to the read and write request or transaction from whichever is the designated “master” at that time and for that particular operation. Further, in the context of the present invention, a “transaction” is defined to be a communications mechanism between a master and target device and preferably is either a “write transaction” (or store transaction) or a “read transaction,” (or load transaction), where a “write transaction” is one where the master device supplies data to the target device for it to act on, and a “read transaction” is one where the master device requests data from the target device. It is noted that “transactions” may also include other types of communications mechanisms, including but not limited to “load” and “store” functions.

Depending upon the complexity and nature of the communications system, multiple masters M1-M4 may be required to have access to, and communicate with, the same target T1-T3 simultaneously, as shown in FIG. 1. The point-to-point connections between masters and slaves should be considered logical in nature; these connections may be made over a shared bus. In such instances, some sort of bus arbitration or bus arbitrator is needed in order to allow and control access to the target's resources from the multiple masters M1-M4. Conventionally, the masters M1-M4 and targets T1-T3 have been connected via some sort of shared bus B, such as shown in FIG. 2. Operationally, each bus master M1-M4 requests control of the bus B from the arbitrator A, and the arbitrator A grants access to a single master at a time. Once a master M1-M4 has control of the bus B, the master performs the desired transaction with the intended target T1-T3. If multiple masters M1-M4 attempt to access the bus B at the same time, the arbitrator A allocates the bus resources to a single master based on predetermined arbitration rules, most often on the basis of criteria such as fairness or priority. All other masters are forced to wait to complete their desired transaction.

It will be appreciated that both data transmission rates and data transfer rates are greatly affected by the confluence of several factors, including the number of devices (or components) having the ability to access the resources of another device (or component). These rates also impact the overall performance of the chip, computer, or similar processing system. While conventional bus architecture as described above may offer design simplicity, even with the aforementioned bus arbitration schemes the bus B generally creates a significant bottleneck in any computer system limiting input/output (I/O) throughput and device utilization. This is particularly true in computer systems with high-performance components, where master and slave components are inherently capable of performing quickly various functions, but whose speed is greatly reduced as a result of waiting for bus access.

One solution that has been proposed, which is shown in FIG. 3, is to eliminate the shared bus architecture and complicated bus sharing arbitration schemes, by connecting the masters M1-M4 and the targets T1-T3 with dedicated communications pathways and implementing arbitrators A1-A3 between those implementations where two or more masters M1-M4 are connected to a single target. Such arbitration is called “slave-side arbitration,” an example of which may be seen in U.S. Pat. No. 6,857,035 (issued on Feb. 15, 2005), assigned to Altera Corporation.

FIG. 3 shows an example of a simple slave-side arbitration scheme, including masters M1-M4, decoders D1-D4, arbitrators A1-A3 and targets T1-T3. A decoder D1-D4 selects the appropriate target T1-T3 and translates the control information including the target addresses based on the information received from the master M1-M4. The decoder D1-D4 checks the “Address” input received from the master M1-M4 to see if it matches the address range of the requested target T1-T3. If there is a match, then the “Command” input signal from the master M1-M4 is passed through to the “Command_Request” output; if the address does not match then the “Command” input is blocked from getting to the “Command_Request” output since the command is not intended for this particular target T1-T3.

The arbitrator A1-A3 dictates which master M1-M4 gains access to the target T1-T3 if it and another master sharing access to the target initiate a transaction with the target at same time. As known to those of skill in the art, the details of the arbitration schemes are application-dependent. Embodiments of the present invention may use any arbitration scheme, including but not limited to “first come/first served,” “priority weighting,” and “round robin.” The arbitrator A1-A3 outputs an individual “Wait” signal to send back to each master device M1-M4 as well as controlling the actual target device T1-T3. At any given time, there will be at most one master M1-M4 that is not being told to wait, while all of the others will be told to wait.

In the example implementation of FIG. 3, master M1 is connected to target T1 through a first decoder D1 and first arbitrator A1; master M2 is connected to targets T1 and T2 through a second decoder D2 and first and second arbitrators A1 and A2, respectively; master M3 is connected to targets T2 and T3 through a third decoder D3 and second and third arbitrators A2 and A3, respectively; master M4 is connected to target T3 through a fourth decoder D4 and the third arbitrator A3. Thus, master devices M1 and M2 have access to the resources of target T1; master devices M2 and M3 have access to the resources of target T2; and master devices M3 and M4 have access to the resources of target T3. FIG. 3 is merely an example of slave-side arbitration, and other architectures are intended to be included within the concept of slave-side arbitration. For example, master devices M1-M4 each may require access to target T1, in which case they would be connected to target T1 through the first arbitration device A1. Slave-side arbitration includes any permutation where multiple masters require access to a particular target (or targets) simultaneously. Again, this also includes those instances where the designation of master/target changes depending upon the particular transaction involved. In addition, while distinct Address/Command lines are shown coming from the second and third decoders D2 and D3 to the first, second and third arbitrators A1-A3, in order to indicate that target T1 through target T3 may have different addresses as seen by masters M2 and M3, it will be appreciated that in those design instances where the address space is common or fixed, a single Address/Command will suffice.

In conventional slave-side arbitration such as shown in FIG. 3, each target device in a slave side arbitration implementation receives at least the following inputs from each master device that is allowed to communicate with the target:
Address. This represents the address that a particular master device is trying to communicate with. The decoder decodes this to see if it is the selected device that the master is trying to access;
Command. This represents the command that a particular master device is to send to the target selected by the “address.” As previously discussed, commands can generally be classified as either:
   A “write transaction” where data is being transferred from the master to the target device; or
   A “read transaction” where a request is being made by the master to transfer data from the target to the master; and,
Write Data (not shown). If the master is attempting to write data to a target, then the Write Data input provides the data that the master is writing to the target. (It will be appreciated that, in those systems where the master either does not write to a target or does not need to provide any specific data on a write to the target, then this particular input need not be implemented).

In turn, each target device in a slave side arbitration implementation generates the following outputs to each master device with which it is allowed to communicate:
Read Data. If the master is attempting to read data from a target, then the “Read Data” output provides the data that the target supplies back to the master as a result of the read. In those systems where the master either does not read from a target or does not need to receive any specific data on a read from the target, this particular output need not be implemented.
Read Data Valid. This output is used to tell a master device that a previously accepted read command has been completed and the data is now available; that is, data that was previously requested is actually available. Depending on the application, this output is optional. Use of this output is particularly desired in those systems that have target devices with a long latency, and in such instances this output will generally improve performance. For example, it will be appreciated that this output may be used when designing a controller for a dynamic random access memory (DRAM), disk drive or memory. In a system where this output is not used, the “Wait” output described below would instead be used to tell the master to wait until the requested read data is actually available.
Wait: This output is used to tell a master device that the target cannot accept the command at this particular time. While the Wait signal is asserted, the master device may not start up another transaction and must hold all of its outputs at their present state.

In a system where multiple master devices are attempting to access a single target, a performance bottleneck arises in the arbitration logic required to implement the “Wait” outputs to each of the master devices based on the “Address” and “Command” inputs from each master device. The crux of the performance problem in current practice slave-side arbitration schemes is that the generation of the “Wait” outputs to each master device is typically a function of a large number of signals and this computation must be performed within a single system clock cycle in order to achieve maximum performance. This scheme also does not tend to scale very well in that as more and more master devices are added, the performance of the final design tends to degrade rapidly.

By way of example, Table 1 below shows an estimate of the performance in a slave side arbitration scheme, such as shown in FIG. 3. In such current practice slave side arbitration scheme, the following assumptions have been made:
Each of the master devices has a 32 bit address bus (22 address bits of which must be decoded to select the target device, where these bits must be decoded by the decoder to determine if a master device is trying to access the target, and 10 address bits of which are used to address areas within the target device);
Each of the master devices has a “Read” signal output and a “Write” signal output to implement the “Command” bus as is referred to herein;
The technology used to implement the “Wait” signal output can implement any arbitrary logic function of 4 inputs within one unit delay;
The arbitration function can be computed simply from the address and command inputs. (It will be appreciated that any arbitration function would have to use these inputs as a minimum, so this assumption is actually a best-case example. More complex arbitration functions would require more input signals).

As can be seen, as the number of master devices increases, and thus the number of arbitration logic input signals (comprising 22 input address bits and a read and write command per master device), so does the number of “unit delays” needed to compute the various “Wait” outputs. (As known, a “unit delay” is simply a relative performance measure that is not linked to any specific technology's implementation. This delay is inversely proportional to system performance, so as the delay increases the performance of the system degrades.):

TABLE 1
Unit Delay Comparison

| Number of Master | Arbitration Logic Input | Unit delays required to |
|---|---|---|
| Devices | signals | compute “Wait” output |
| 1 | 24 | 3 |
| 2 | 48 | 3 |
| 3 | 72 | 4 |
| 4 | 96 | 4 |
| 5 | 120 | 4 |
| 6 | 144 | 4 |
| 7 | 168 | 4 |
| 8 | 192 | 4 |
| 9 | 216 | 4 |
| 10 | 240 | 4 |
| 11 | 264 | 5 |
| 12 | 288 | 5 |

The other basic difficulty with prior slave-side arbitration implementations is “routing congestion.” As the number of master devices requiring access to a target increases, it becomes extremely difficult to arrange the logic and routing resources required without degrading overall performance using known slave-side arbitration schemes. Thus, current slave-side arbitration schemes have the advantage that, to the extent that two masters are not trying to access simultaneously the same target, the system will have the highest possible throughput since each master will appear to have exclusive access to the target to which it desires access. The master's inherent speed utilization will not be slowed waiting for some other master device communicating with some other target. Again, however, this advantage disappears as more master devices require access to a target. An increasing number of master devices requiring access to a target will result in the aforementioned routing congestion and performance bottleneck, and at some point, the slave-side arbitration scheme will have no performance advantage over other arbitration schemes, appearing as conventional bus architecture.

The present invention seeks to overcome these performance disadvantages in slave-side arbitration and to provide an improved slave side arbitration scheme that does not have this performance degradation regardless of how many master devices are involved.

### SUMMARY OF THE INVENTION

The present invention provides arbitration with improved performance through queuing devices logically placed between respective master devices and at least one corresponding target device.

According to one embodiment, this may be a system where multiple master devices may access to a target device. The target device is configured to fulfill transactions respectively requested by the plurality of master devices, such as a first and second master device. An arbitrator is in operative communication with the plurality of master devices and the target device, and arbitrates access to the target device in relation to the transactions respectively requested by the plurality of master devices. A first queuing device receives transaction requests from the first master device and communicates information regarding retained transaction requests to the arbitrator, and a second queuing device receives transaction requests from the second master device and also communicates information regarding its retained transaction requests to the arbitrator. The arbitrator arbitrates access to the target device based upon an arbitration scheme and the communicated information regarding retained transaction requests.

In one embodiment, the queuing devices are FIFO devices. A portion or all of the system may be integrated within a FPGA in an image capture subsystem of a document processing system. In one example, the master devices may include an image lift device and a host processor device, and the target device may be a common memory device accessed by the master devices.

Another aspect provides an integrated circuit wherein multiple processors are the master devices and a memory interface device is the corresponding target device. Still another aspect provides a document processing system having multiple master devices and at least one target device, with the queuing devices receiving transaction requests from respective master devices and communicating information regarding retained transaction requests to the arbitrator. With the document processing system, examples of master devices include but are not necessarily limited to an image capture processor for storing raw camera data after detection by an image lift device, a top/bottom statistics processor for storing location of the top and bottom of each scan line of incoming video, a histogram statistics processor for storing document histogram data collected from the image lift device, a compressor input processor for reading document pixel data to be compressed, and a compressed output processor for storing compressed document data.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a diagram illustrating a system where multiple masters require access to the same target simultaneously in a conventional fashion;

FIG. 2 is a block diagram illustrating a system where multiple masters access a target via a conventional shared bus architecture;

FIG. 3 is a block diagram illustrating a system where multiple masters access a target using slave-side arbitration architecture in a conventional fashion;

FIG. 4 is a block diagram of a system having an improved slave-side arbitration architecture including memory queues in accordance with an embodiment of the present invention;

FIG. 5 is an I/O block diagram of selected components of the system of FIG. 4 illustrating how a master is connected to access a target in accordance with an embodiment of the present invention;

FIG. 6 is a schematic of a document processing system in which the present invention may be used;

FIG. 7 is a block diagram illustrating the major subsystems of a document processing system of FIG. 6, including an imaging subsystem;

FIG. 8 is a high-level functional block diagram illustrating the basic functionality and communications paths in an imaging subsystem such as in the document processing system of FIG. 7;

FIG. 9 is a functional block diagram illustrating the data paths according to an embodiment of the present invention in the imaging subsystem of the document processing system of FIG. 7;

FIG. 10 is a block diagram illustrating how the various masters and targets in the imaging subsystem of the document processing system of FIG. 7 are interconnected according to an embodiment of the present invention; and

FIG. 11 is a block diagram illustrating an alternative embodiment of the present invention in a multi-processor core environment.

FIG. 12 is a flowchart of a slave-side arbitration method using FIFO devices according to the present invention.

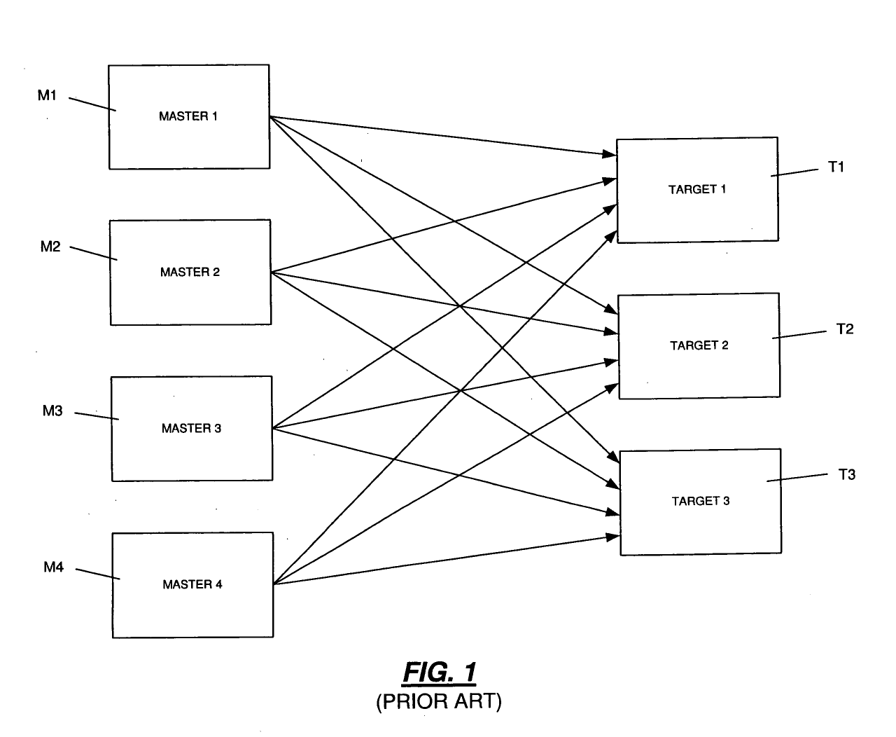

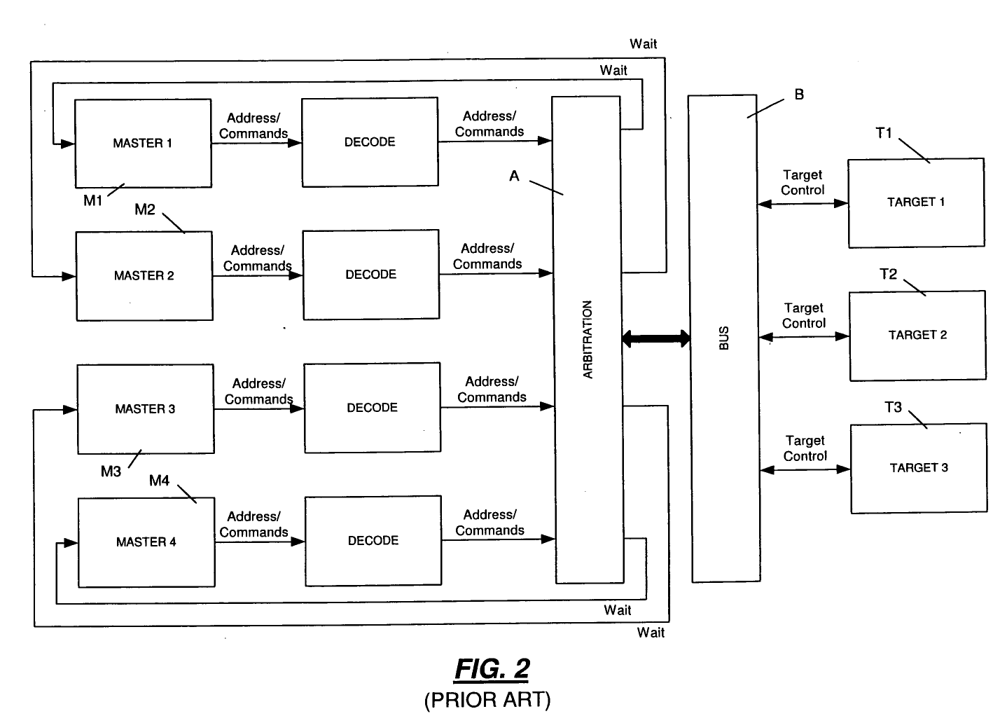

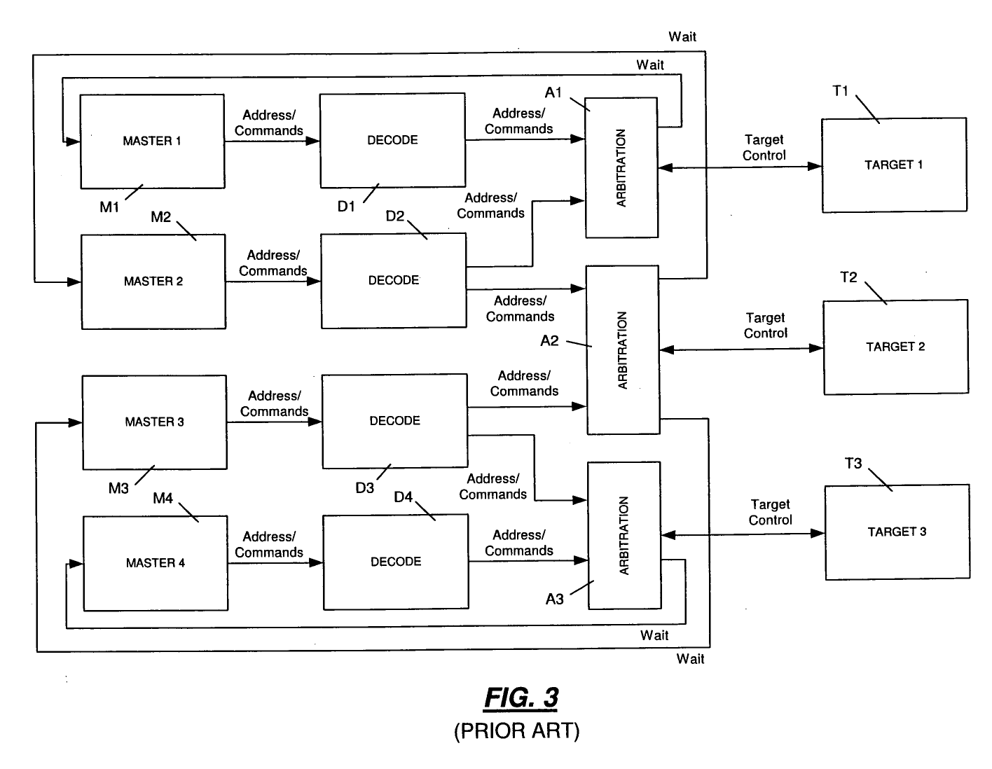

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

According to one embodiment, the present invention provides improved target access arbitration where multiple master devices may access to a target device. The target device is configured to fulfill transactions respectively requested by the master devices. An arbitrator is in operative communication with at least one target device and arbitrates access to the target device in relation to the transactions respectively requested by individual ones of the master devices. For example, a first queuing device receives transaction requests from a first master device and communicates information regarding retained transaction requests to the arbitrator, and a second queuing device receives transaction requests from a second master device and also communicates information regarding its retained transaction requests to the arbitrator. The arbitrator arbitrates access to the target device based upon an arbitration scheme and the communicated information regarding retained transaction requests.

In one embodiment, the queuing devices are FIFO devices. Additionally, a portion or all of the system may be integrated within a FPGA in an image capture subsystem of a document processing system. In one example, the master devices may include an image lift device and a host processor device, and the target device may be a common memory device accessed by the master devices.

As noted previously, a critical timing path in a slave-side arbitration logic scheme is the path starting from a particular master device's “Address” and “Command” outputs through the slave side arbitration logic and back to the master device's “Wait” input. The present invention overcomes these performance disadvantages and provides an improved slave side arbitration scheme that does not have this performance degradation regardless of how many master devices are involved. In one embodiment, a first in, first out (FIFO) memory queue or data buffer respectively provided for each master device improves the overall performance of the system. The FIFO device is preferred, but it is noted that other queuing devices may also be provided. For example, in certain situations, it may be desirable to rearrange the order of some of the reads and writes before sending them to the target device, or it may be desirable to hold a write in favor of fulfilling a series of subsequently occurring read transactions. These types of circumstances may warrant a queuing device other than a pure FIFO device.

As known, a FIFO device is a device used for buffering and data flow control. In the present application, the terms “FIFO,” “FIFO device,” “FIFO memory queue,” and “FIFO buffer” may be used interchangeably to refer to the same type of device. It will also be understood that the FIFO device can be affected in software. Typically, a FIFO device has a minimum set of interface signals, including input and output signals. The input signals of a FIFO device generally include: a “Write Data” signal, which contains the data that is to be loaded into the FIFO device; a “Write” signal used to command that “Write Data” should be loaded into the FIFO device and that the count of how many items are in the FIFO device should be incremented; and, a “Read” signal, which is used to command that data should be unloaded from the FIFO device and made available on “Read Data” (discussed below) and that the count of how many items are in the FIFO device should be decremented. Similarly, output signals of a FIFO device generally include: a “Read Data” signal which contains the data that has been unloaded from the FIFO device; an “Empty” signal that indicates when the FIFO device has nothing in it and should not be read from; and, a “Full” signal that indicates when the FIFO device is full and should not be written to.

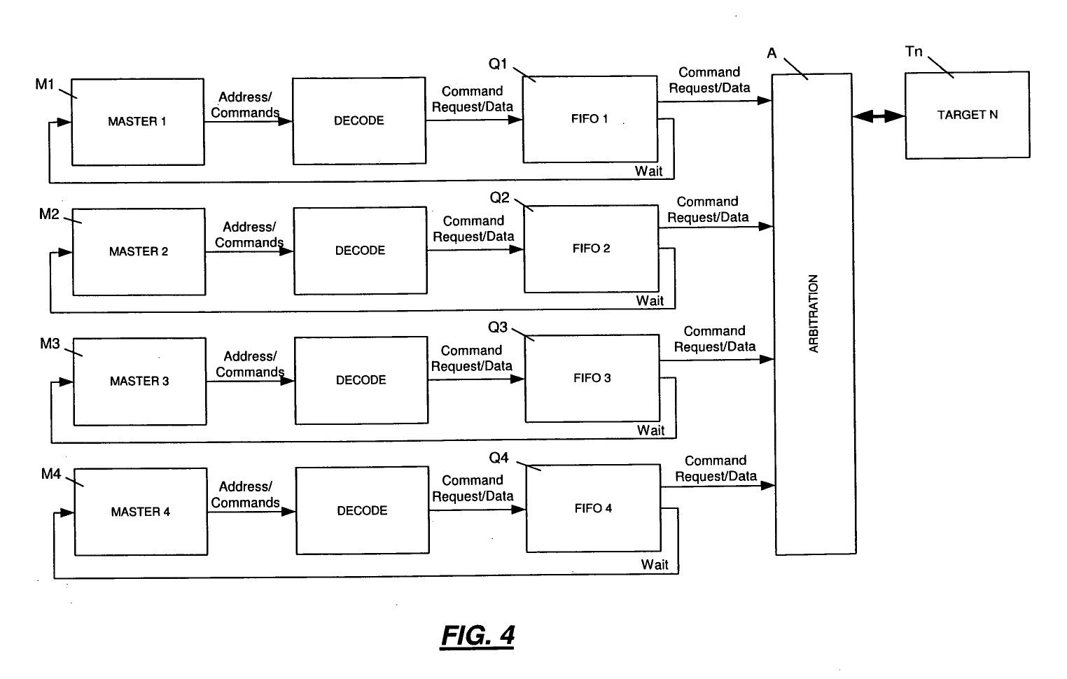

FIG. 4 is a block diagram illustrating an embodiment where four master devices M1-M4 require access to a target device Tn. Four is merely illustrative, as the present invention applies to any plurality of masters requiring access to a target. As seen, queing devices in the form of FIFO buffers Q1-Q4 are connected between each master device M1-M4 and the arbitrator A; thus, each master device M1-M4 communicates with a FIFO device Q1-Q4 dedicated to servicing only this master. The “Wait” signal output that is fed back to the master device M1-M4 is an output of the FIFO device Q1-Q4 instead of being an output of the arbitration logic. In a preferred embodiment of the invention, the “Full” output status signal from each FIFO device Q1-Q4 is used as the “Wait” signal output that is then fed back as the “Wait” input to the master device M1-M4.

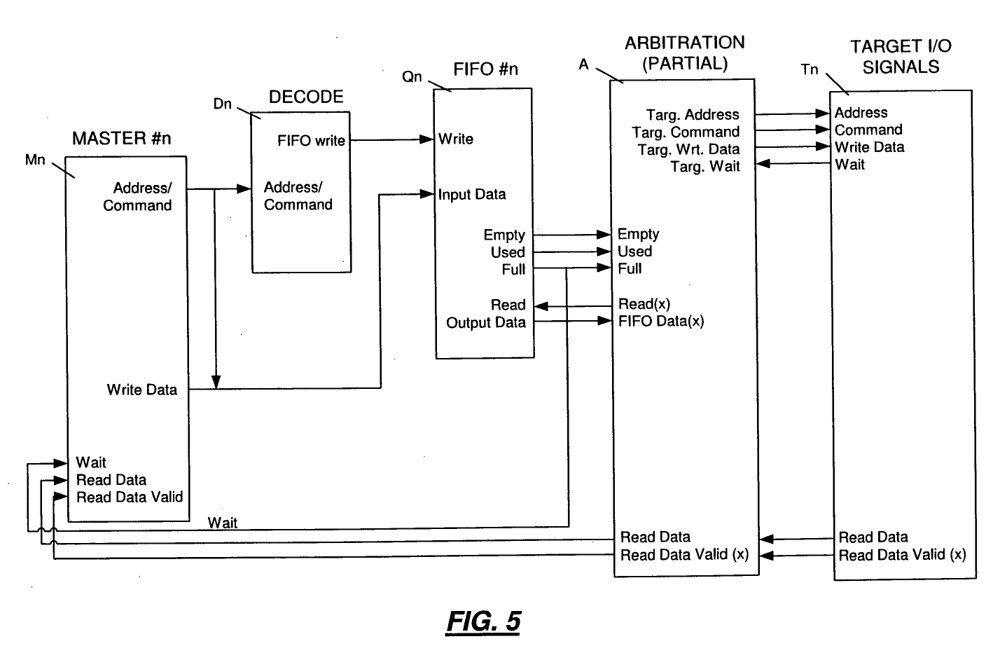

FIG. 5 is a block diagram illustrating the interconnections in more detail. A master device Mn is connected to a FIFO device Qn through decode logic Dn, and then to the target device Tn through arbitration logic A, where n indicates one of a total of m masters, and thus of a corresponding m FIFO buffers in the system. The arbitration logic A as illustrated in FIG. 5 is relatively simplified so as to not to unnecessarily obscure the features of the invention. As with conventional slave-side arbitration schemes, each master that has access to a target may share arbitration logic with the other masters also having access to that target. Thus, the arbitration logic A in FIG. 5 is designated as partial.

In an embodiment, the primary input to the arbitration logic A is the FIFO “Empty” signal that is output from each FIFO device Qn. The arbitration logic A scans the set of “Empty” inputs received from its “assigned” FIFO devices, and using any known arbitration scheme, determines which master device Mn should be granted access to the target Tn. If the “Empty” status bit for FIFO Qn is not set, this implies that master Mn has put something into the FIFO Qn causing it to be no longer empty which, in turn, implies that master Mn is requesting to communicate with the target Tn. The arbitration logic A thus uses the “Empty” status signal from each master's FIFO device Qn to decide to which master device Mn it should grant access. For the device Mn that has been chosen, the arbitration logic A then asserts the “Read” command to that particular FIFO device (e.g., FIFO Qn). In response to the “Read” command, the chosen FIFO device Qn then outputs one entry (i.e., “Address,” “Command” or “Write Data”). Once the transaction with the target device Tn has been completed, the arbitration logic repeats the task of scanning its set of “Empty” inputs to determine which master device Mn should next be granted access to the target Tn.

It is recognized that the “Output Data” line of the FIFO Qn and the “FIFO Data” input line to the “Arbitration (Partial)” block A may comprise more than just “data.” This may also include whatever information the target device Tn requires; including, “Address,” “Command,” and “Write Data.” For example, if the target device Tn requires 10 bits of address, a single bit “read” command, a single bit “write” command and an 8 bit data bus for writing data, then there would be a total of 20 bits of data that would be captured and stored by FIFO device Qn so that they could then be passed along to the target Tn.

It is readily understandable from the above description how the address, command, and data flow in the system of the present invention when a particular master device Mn writes data to a target Tn. The following sets forth the data flow in the present invention when a master device Mn attempts to read data from the target Tn.

The “Read” command can be broken down into two somewhat autonomous “mini” transactions. More particularly, the “Read” command may be thought of as comprising: a request by a master device Mn to read data from a particular address from the target device Tn. From the perspective of controlling the FIFOs Qn and the arbitration logic A, this step of the process is handled in the same manner as if the master Mn had requested a write. Secondly, it may be thought as including the additional step of supplying the data read from the target Tn back to the master Mn. This aspect will be discussed more fully below.

When master Mn initiates a read from a target device Tn, the necessary address bits and the read command are captured into FIFO Qn exactly the same as is done with a write command. Since there is now something in FIFO Qn, the arbitration logic A will arbitrate among the various requestors and at some point pass along the address and read request to the target device Tn. No special handling is required to be done in the arbitration logic A different for a read or a write.

Eventually the target device Tn will supply the data that was requested to be read via the “Read Data” inputs shown in FIG. 5. There will also typically be some sort of signal to indicate that the data is in fact valid (e.g., the “Read Data Valid” input). Once the arbitration logic A receives valid data as the result of a read it then passes it back to the master device Mn that requested that data. Since each master that potentially can read from the target will need access to this read data, it can in fact be routed unchanged to each master in parallel if desired. The only signal that needs to be unique is the “Read Data Valid” output for which there is one arbitrator output for each master device.

It will be appreciated from FIG. 5 that, unlike prior slave-side arbitration schemes, the delay to compute a “Wait” signal output in the slave-side arbitration system of the present invention does not depend on the number of masters in the system that have access to the target (or associated arbitration logic), nor does it depend upon the complexity of the arbitration algorithm/scheme. Instead, the delay from the “Address” and “Command” outputs of a master device Mn to the computation of the “Wait” signal input to that master depends only on the number of address and command inputs that need to be decoded in the decode block Dn and the delay to compute the “Full” output in the FIFO Qn block corresponding to the given master device Mn.

Thus, the full arbitration logic required to process all target device requests from all of the master devices does not need to complete the arbitration function within one system clock cycle in order to achieve full performance. The only requirement is that the depth (i.e., the number of entries that can be written into an initially empty FIFO device before a “Full” output gets set under the condition that “Read” input is not asserted) of each of the FIFOs must be greater than the number of system clock cycles required to implement the arbitration function. Thus, for example, if the arbitration function requires 2 system clock cycles to complete, then each FIFO device should be a minimum of 3 entries deep.

This embodiment improves slave side arbitration by providing system performance independent from the number of master devices. With regard to this, unlike conventionally implemented slave-side arbitration schemes, where the critical path to implement the “Wait” signal output was a function of the number of masters that need access to a target, the performance of the present invention is independent of the number of master devices. For a system with target devices that require arbitration (i.e., anything more than one master) this feature results in increased system performance of the entire master to target device connection

Another area of improvement is system performance independent of the arbitration algorithm. In general, the arbitration algorithm used depends heavily on what the particular system application is and what the requirements of that system are. If the parameters of the arbitration algorithm were also required to be considered in the critical tinting path and required to be implemented in less than 1 system clock cycle, the system clock cycle itself would be greatly limited. By removing this requirement and allowing the arbitration function to be implemented in however many clock cycles are required will, in most cases, allow for a higher system clock cycle to be used, thereby increasing performance. Although FIFO depth must be considered in design criteria, the present invention allows for the arbitration function to be pipelined and to take more than one clock cycle to complete, without affecting system performance.

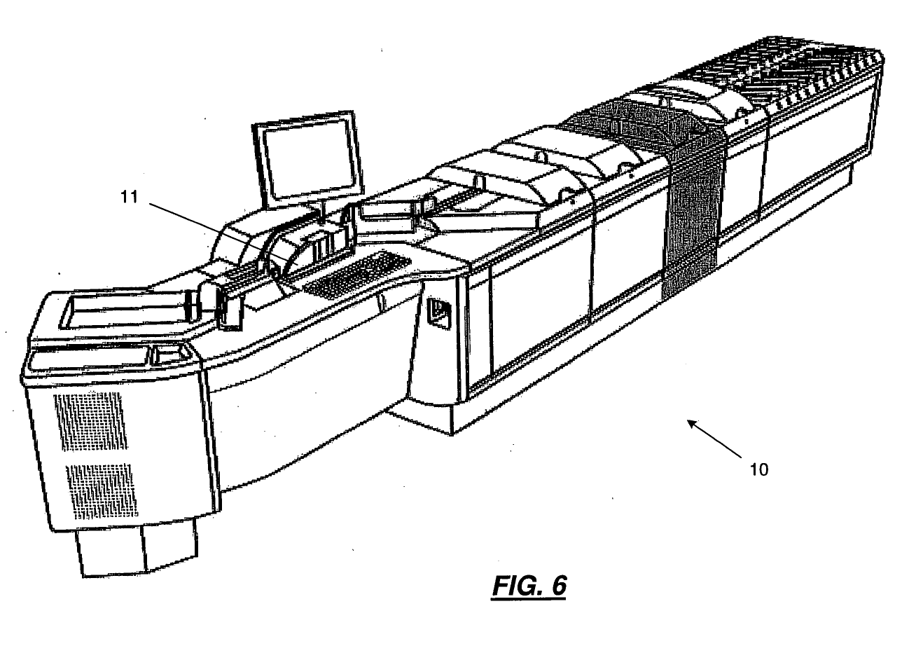

In one embodiment, the present invention is implemented in a document processing system 10, as illustrated in FIG. 6. The document processing system 10 can be, for example, the SourceNDP, NDP 110, NDP Quantum Series 200, 300 or 600, or NDP Series 850, 1150, 1600, 1825, and 2000 systems, all of which are available commercially from Unisys Corporation, Unisys Way, Blue Bell, Pa. 19424.

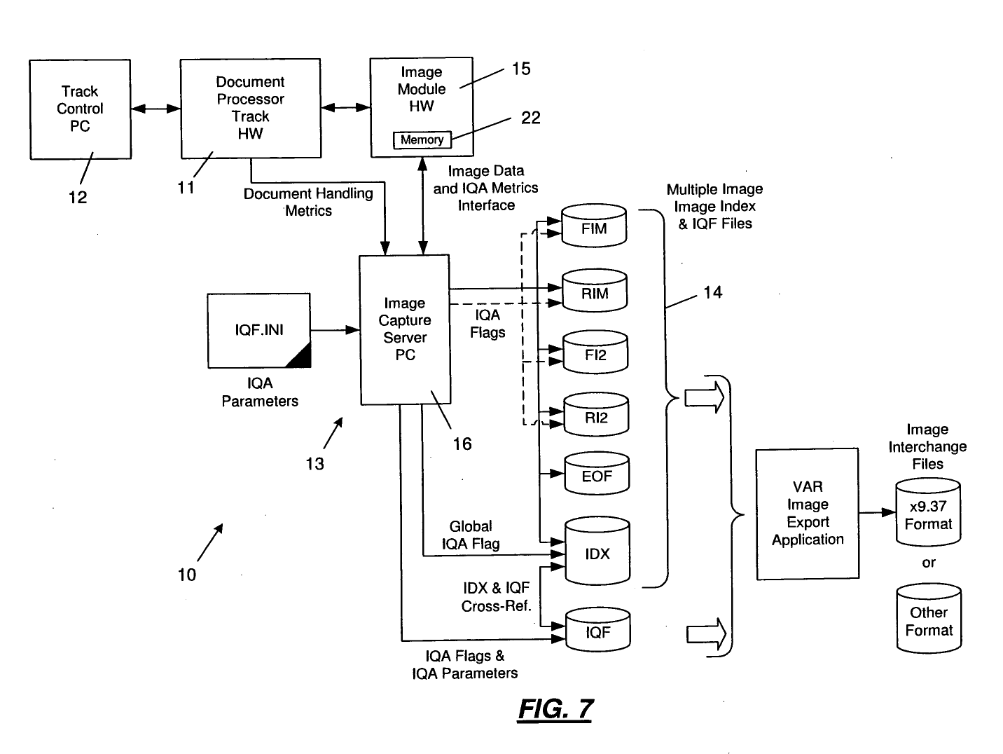

As known in the art, a conventional document processing system 10 includes a transport with various processing options. The various processing options, when installed, become an integral part of that system's transport mechanism. As the document passes through one of the installed subsystems, the hardware for that installed subsystem performs whatever function it was designed to perform. FIG. 7 is a block diagram illustrating subsystems of the document processing system 10 of FIG. 6.

The document processing system 10 includes track hardware 11, a track controller or PC 12 for controlling the document movement along the track hardware 11, and an imaging subsystem 13 for capturing and processing electronic images of the documents being transported through the system 10, and for storing the captured images. The document processing system 10 may also include other subsystems, such as a MICR reading subsystem; an encoding subsystem (i.e., printing of additional information on the document); and/or a microfilming subsystem (for capturing a film image representation of the image of the document), and any other options and subsystems as known to those of skill in the art.

Operationally, documents are physically processed through the transport hardware 11 of the document processor under the control of track control PC 12. Track control PC 12 provides sorter control of the document transport hardware 11, and includes track applications, such as in clearings, proof of deposit, and remittance operations, and system software, which in an exemplary embodiment of the present invention, is WINDOWS NT®, WINDOWS 2000®, or WINDOWS XP®-based system software. The system software preferably includes Unisys Common Application Programming Interface, or CAPI, which is a common application programming interface that enables the same application software to be used across multiple transport platforms. The image capture subsystem 13 provides image server and capture capabilities and interfaces with the document transport hardware 11 to receive images moved by document transport and to store them in appropriate files 14 (e.g., FIM, RIM, FI2, RI2). The image capture subsystem 13 generally comprises both hardware and software, including imaging module hardware 15, having a camera subsystem for capturing images, and an image capture server (ICS) PC 16 for processing and storing the images. The details of the document processing system 10 can have various forms, such as those described in U.S. Pat. No. 7,167,580 assigned to Unisys Corporation.

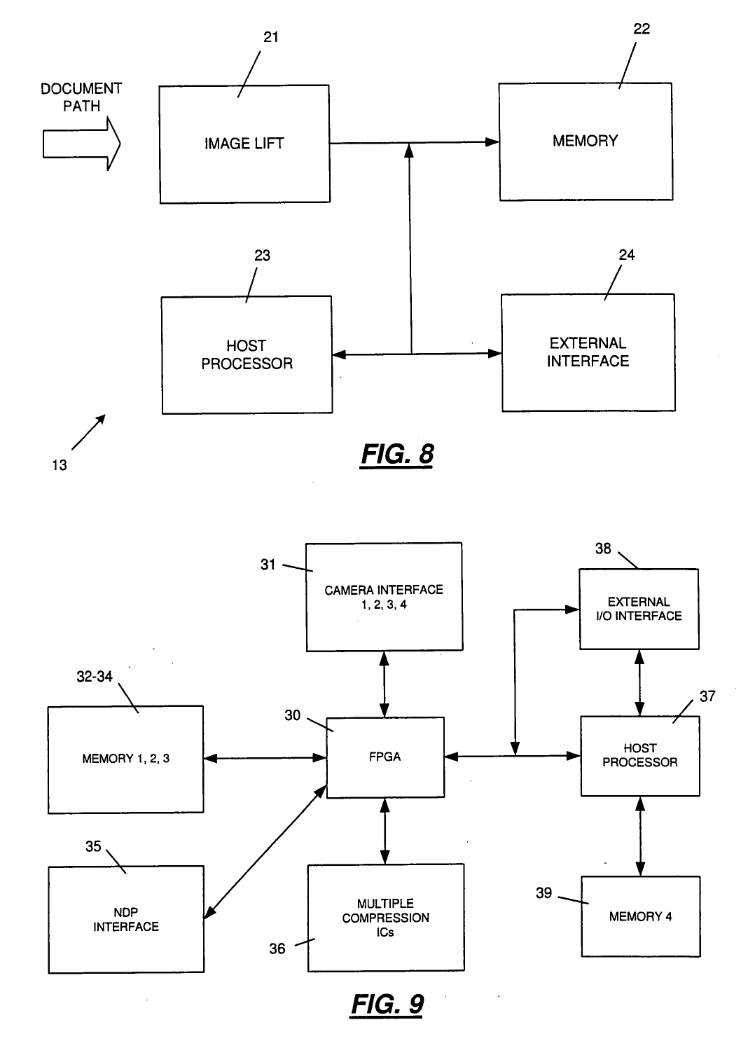

The image capture subsystem 13 of the document processing system 10 shown in FIGS. 6 and 7 may be functionally represented, at a high level, as shown in FIG. 8. The image capture subsystem 13 shown in FIG. 8 includes four basic blocks. However, it is noted that, as this is a functional representation, each block does not necessarily uniquely correspond to a separate device or component within the document processing system 10, but rather a defined function; thus these functions may span across more than one device or component at any given time.

Light reflected off of the document moving in the track 11 is reflected back and input to the image lift function 21. The image lift function 21 serves two basic functions. First it converts the light input reflected from the document into the camera subsystem into analog electrical signals and then digitizes them into a digital number representative of the physical brightness of an individual pixel. For example, 0 may represent pure black; 255 may represent pure white; and 1 thru 254 may represent various shades of gray that correspond to the light/darkness of an individual pixel. A scanned document will include a large number of such pixels. As an example, a document that is physically 6 inches wide by 3 inches tall when scanned at 200 dots per inch will consist of 6×200×3×200=720,000 pixels. In one embodiment, the image lift function 21 can be performed by a camera subsystem, which may be implemented in a camera printed circuit board.

It will be appreciated that the image capture subsystem 13 has no a priori knowledge of the actual size of the document or exactly when it will be passing through the document processing system 10. This is the second functionality that the image lift function 21 provides; that is, the image lift function 21 performs a document framing function. Document framing includes finding the right and left bounds of the document as it passes in front of the camera. For example, if a document is moving through the document track 11 and passing horizontally in front of a vertically oriented scanner used to detect the light level reflected back into the image lift function 21, the scanner must be physically tall enough to capture light from the tallest possible document that the document processing system 10 is designed to accommodate. However, it is not until the entire document has physically passed in front of the scanner that the image capture subsystem 13 is able to fully define the outermost boundaries of the electronic representation of the image. For this reason, the image lift function 21 typically must have some form of memory storage, depicted in FIG. 8 as memory 22, associated with it to store the raw camera data as it comes in from the camera subsystem so that only the relevant portion that actually represents the document can be later processed. In one embodiment, the document boundary defining functionality of the image lift block 21 and the memory 22 are implemented on an image processor board in the image capture subsystem 13.

After the image data has been stored in the memory 22, the processor function, depicted in FIG. 8 as host processor 23, performs analysis of the captured data in the memory 22 to determine the precise location of the image, and then compresses this image and sends it out through an external interface 24 for further processing and image storage (e.g., to the image capture server (ICS) PC 16). This same external interface 24 typically also controls the imaging subsystem 13; passing it parameters and enabling/disabling the image functionality as required by the document processing system 10. In a preferred embodiment, the host processor 23 and the external interface 24 are also implemented on the image processor board in the image capture subsystem.

Thus, it will be appreciated from the above discussion that, in a conventional document processing system; at a minimum, two (2) masters (i.e., the “Image Lift” and “Host Processor”), are requiring access to a single target (“Memory”), which implies that there must be some form of arbitration function that regulates usage of the “Memory.” However, in mid-range and high speed document processing systems, such as shown in FIG. 7, an imaging subsystem implemented with common electronic parts and processors and conventional arbitration does not have enough performance to meet the high throughput requirements. In order to improve system performance, the “Image Lift” and “Processor” functionality of the imaging subsystem may be split into smaller more specialized functional blocks.

More specifically, the “Image Lift” functionality might be designed to include a dedicated function for finding the top and bottom of each vertical scan line in the document image and writing this information to memory. By doing this, “Host Processor” is able to determine the boundaries of the image (top, bottom, left, right) without needing to access individual pixels (and thus “Memory”) that make up the image itself. Similarly, the “Image Lift” function might include dedicated hardware to compute the histogram of the incoming document image and store the results in “Memory” (As known, a histogram is a count of how many pixels of each gray level occurred in the image. It is computed typically to provide information that can be used to either improve the quality of the image or to detect an unusual document (Example: an all black document.)). By using such “Image Lift” dedicated hardware, “Host Processor” does not need to access each individual pixel in the document in order to compute the histogram. It will be appreciated that these are only two examples where the “Image Lift” function can be designed to provide additional information and functionality while the data is being received, which will greatly cut down on the amount of data that “Host Processor” will need to handle and thus improve “Processor” performance. As known, other similar designs where dedicated functionality is implemented are included in the scope of the present invention.

The “Host Processor” also can be modified to include additional dedicated hardware that can greatly improve its performance. As stated earlier, typically the output image is in some compressed data format (e.g., JPEG and ITU T.6 are two commonly used formats. However, any other compressed data format may also be used). One way to improve performance of “Host Processor” is to have dedicated hardware to provide a separate compression function. In such an instance, the image data is initially stored in “Memory,” for later retrieval by the compression processors. Similarly, after the compression processors compress the image data, the compressed data output also is typically stored in “Memory.”

In the aforementioned discussed system, “Host Processor” blocks conventionally include the following processors:
Image Capture (Storing of raw camera data after it has been detected by the image lift);
Top/Bottom statistics (Storing of the location of the top and bottom of each scan line of incoming video);
Histogram statistics (Storing of document histogram data collected from the image lift after it has detected the document);
Compressor Input (Reading of document pixel data that is intended to be compressed);
JPEG Compressed Output (Storing of document data that has been compressed per the JPEG algorithm); and
ITU T.6 Compressed Output (Storing of document data that has been compressed per the ITU T.6 algorithm).

In addition, depending on the particular function and performance needs of the document processing, additional devices and processing functions may be required to have access to “Memory” as well. For example, an imaging subsystem that can simultaneously collect image data from both the front and rear of the document as it passes through the system would require two sets of the above mentioned six (6) processors, or twelve (12) processors that all need access to the shared “Memory.”

In general, adding these specialized functional blocks greatly improves “Host Processor” performance and thus system performance. However, it will be appreciated that the addition of these specialized functional blocks results in an imaging subsystem that has several processor data paths that are all competing for access to “Memory.” These additional data paths introduce a further design concern.

As known, every resource (or target) has some upper performance limit that is part of the specification for the part itself, and many targets can only achieve their top performance when working on large “blocks” of data. Since each processor that needs to access memory is likely to be working in a separate area of memory or performing a different operation with that memory, in order to get the best performance when sharing a target between multiple masters, transactions and other operations from a given master are grouped together in order to minimize the amount of switching between processors. The downside to minimizing switching between processors is that it tends to increase the latency that each processor perceives when accessing the target, since it must typically wait longer to get access to the target.

As will be appreciated from above, added specialized functional blocks results in improved “Host Processor” performance, but also requires that an imaging subsystem have several processor data paths that are all competing for access to the “Memory”; i.e., multiple masters requiring access to a single target. While slave-side arbitration was considered to address this, in view of the above additional design constraints and performance considerations, further enhancements were required in order to reduce the latency perceived by each processor function.

A FIFO memory queue or data buffer for each master function in the slave-side arbitration substantially improves the overall performance of the imaging system. An embodiment of the architecture for the Image Processor board of the Unisys NDP Series document processing system implementing an embodiment of the present invention is shown in the functional block diagram of FIG. 9.

As seen therein, a field-programmable gate array (“FPGA”) 30 is provided which communicates with and/or manages several other functions, including, but not limited to, camera interfaces 31, memories 32-34, NDP interface 35, multiple compression ICs 36, host processor 37, and external I/O interface 38. In one embodiment, the FIFOs Q1-Qn of the present invention are integrated within the FPGA 30, although they also may be discrete components. It will be appreciated that the FIFO devices Q1-Qn can also be effected in software. It will also be appreciated that, while the FGPA 30 is the preferred device, it may instead be an application-specific integrated circuit (ASIC) or similar programmable integrated circuit or in complex programmable logic device (CPLD) or programmable array logic (PAL), or similar logic device.

As seen in FIG. 9, the FPGA 30 has the only direct (and fastest) connection to the first three memories 32-34. Similarly, the host processor 37, which is a common processor used for many video and image applications, has direct access to a fourth memory 39. The FPGA 30 has an indirect path to the fourth memory 37, and accesses it by requesting use from the host processor 37. Similarly, the host processor 37 has an indirect path to the memories 32-34 by requesting use of it from the FPGA 30.

In this embodiment, the architecture of the board may be optimized so that high-speed camera data coming in from the four camera interfaces 31 (discussed in more detail below) flows through the FPGA 30 and is written into either the first memory 32 or the second memory 33. Similarly, the FPGA 30 provides a high-speed flow for data being read out of the first memory 32 or the second memory 33, providing it to the multiple compression ICs 36. As compressed data comes back out, it flows into the FPGA 30, which then writes it to the fourth memory 39 by requesting use from the host processor 32.

As image data from the camera is coming into the FPGA 30, the “document framing” portion of the “Image Lift” function is performed. Only data between these bounds is actually written to the first memory 32 or the second memory 33. The other function that is performed is to compute some statistics on the document data as it comes in, such as finding the top and bottom of the image for each scan line and a histogram of the image data. These statistics are computed by the FPGA 30 as camera data is input and then written to the fourth memory 39 (again via requesting use of the memory 39 from the host processor 37).

Based on the document statistics and the amount of document data collected, the host processor 37 computes the boundaries of the areas to compress. In this example, the image processor board of the document processors, such as shown in FIGS. 6 and 7, may provide for up to five (5) images: Front JPEG, Rear JPEG, Front ITU T.6, Rear ITU T.6 and high resolution front JPEG. The host processor 37 then writes to various registers inside the FPGA 30, which cause the FPGA 30 to initiate the flow of data from the first, second or third memories 32-34 through the multiple compression ICs 36 and finally out to the fourth memory 39.

In an embodiment, a two-pass operation is required to compute the front and rear JPEG images, where the first pass produces a reduced resolution image. The reduced resolution image is then JPEG-compressed. This function is handled in the FPGA 30 as well. In parallel with ITU T.6 compression, the image data being read from the first memory 32 or the second memory 33 is simultaneously sent to a separate chip to perform the compression function as well as used internally to compute a reduced resolution image. This reduced resolution image is then written to the third memory 34.

In order to optimize use of the available bandwidth of the memory devices, the following multiple data paths were determined:
Camera data from cameras 1 and 2 (the two front cameras) are only written to the first memory 32;
Camera data from cameras 3 and 4 (the two rear cameras) are only written to the second memory 33;
Uncompressed reduced resolution image data from all cameras are written to the third memory 34;
Camera document statistics and all compressed image data are written to the fourth memory 39; and
The fourth memory 39 is also the primary high-speed read/write memory used by the host processor 37.

This design is such that the data paths that transfer more data have more direct and higher performance connection to the designated memory whereas paths that have smaller data transfer requirements use one of the indirect paths. To accommodate these requirements the FPGA block 30 has to manage four target devices (memories 32-34 and 39).

The FPGA design to each of these four targets uses the improved slave side arbitration logic including the queuing devices (e.g., FIFOs) of the present invention, which may collectively be referred to as a “Junction.” More specifically, a “Junction” may refer to the full set of FIFOs (one for each master) and related arbitration logic. The “Junction” is parameterized so that it knows how many masters require access to the target and how much buffering should be provided for each master device. The amount of buffering is selectable for each master independently.

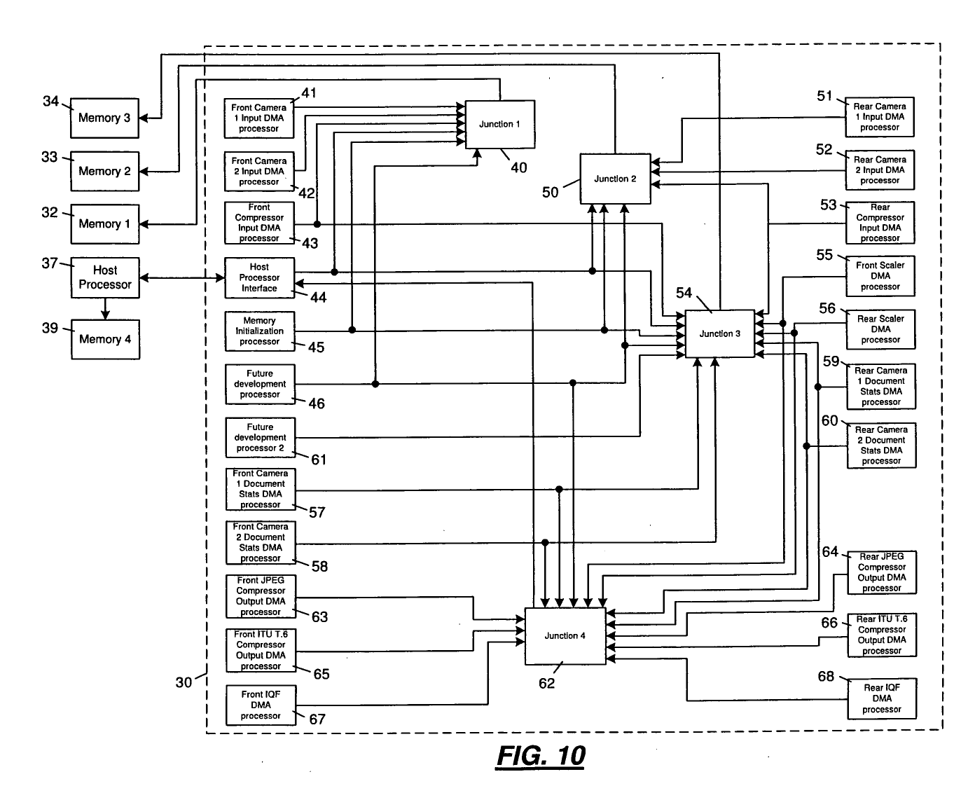

FIG. 10 illustrates within the dashed line an example of the contents of an FPGA in more detail. In this example, the first junction 40 is internal to the FPGA 30 and controls the target device 32 (“Memory 1”) and has six (6) master devices 41-46 that it arbitrates. The master devices are:
Front Camera One Input DMA processor 41. This corresponds to the “Image Lift” function where the camera data is written from the document into “Memory,” as set forth above. The “Host Processor” initializes this Front Camera One Input DMA processor 41 by telling it just where exactly in memory to put the document data;
Front Camera Two Input DMA processor 42. The embodiment of the document processing system implementing the present invention can accommodate up to four camera inputs; two capturing images of the front of the document, and two capturing images of the rear of the document. The two cameras have different optical filters, one is essentially clear; the other is red-tinted so that certain shades of red on the document “drop out.” Front Camera Two Input DMA processor 42 writes the camera data from the second camera. Front Camera One Input DMA processor 41 and Front Camera Two Input DMA processor 42 perform exactly the same function; they are just connected to different camera input sources;
Front Compressor Input DMA processor 43. Again, as mentioned earlier, once the data has been written to “Memory,” the “Host Processor” will determine what sub-region should be compressed for export. Once it determines the coordinates of this sub-region it initializes registers in the Front Compressor Input DMA processor 43, which tell it from where in memory it should get the image. The Front Compressor Input DMA processor 43 then reads this block of memory and sends the data into a compression pipeline. The compression pipeline will perform an image compression function (i.e., JPEG, ITU T.6, etc.). This processor 43 is concerned only with sourcing the data into the pipeline, collecting the compressed data output will be discussed later; it is performed by a different processor;
Host Processor 37 and Interface 44. The host processor 37 is basically an off-the-shelf general purpose CPU of sorts that is preferably implemented in a separate chip. This processor 37 does not need to access the memory device target for much information which is why, in a preferred embodiment, it can only do so via the “indirect” path;
Memory initialization processor 45. For diagnostic and debug purposes, there is a simple processor 45 used for initializing and testing the memory so it is also a master device competing for use of this memory 32; and
Provisions for an internal Control Processor 46 for future development. In an alternate embodiment, the host processor 37, currently an external chip, is implemented into the FPGA 30. Alternatively, this other processor 46 can be used to perform other functions to implement new features entirely. Preferably, the first junction device 40 that implements the invention needs to support the processor 46 like any other processor port.

Also internal to this example of the FPGA 30 is a second junction 50 which controls the second target device 33 (“Memory 2”). The second junction 50 also preferably has six (6) master devices that it arbitrates. The six masters are:
Rear Camera One Input DMA processor 51. Same as Front Camera One Input DMA processor 41 but for controlling video from the rear camera;
Rear Camera Two Input DMA processor 52. Same as Front Camera Two Input DMA processor 42 but for controlling video from the rear camera;
Rear Compressor Input DMA processor 53. Same as Front Compressor Input DMA processor 43 but for controlling video along the rear compression path;
Memory initialization processor 45. Same as mentioned for the first junction 40;
Host Processor 37. Same as mentioned for the first junction 40; and,
Provisions for an internal Processor 46 for future development. Same as mentioned for the first junction 40.

A third junction 54 of the exemplary FPGA 30 controls the third target device 34 (“Memory 3”) and preferably has twelve (12) master devices that it arbitrates. The twelve (12) masters are:
Front Scaler DMA Processor 55. This processor 55 takes the raw front document image and scales it down to a lower resolution and then writes it to the third memory 34;
Rear Scaler DMA Processor 56. Same as Front Scaler DMA Processor 55 but for rear images;
Front Compressor Input DMA processor 43. Same as mentioned under the first junction 40. Once the Front Scaler DMA Processor 55 has computed the lower resolution image and written it to the third memory 34, this processor 43 will come along later and read this lower resolution image and send it into the compression pipeline;
Rear Compressor Input DMA processor 53. Same as mentioned above for Front Compressor Input DMA processor 43 but working with lower resolution rear images;
Front Camera One document statistics processor 57. In some applications there may not be enough bandwidth for document statistics to be written directly into the fourth memory 39 without dropping data. For those scenarios a higher speed connection for camera document statistics from front Camera One is provided to the third memory 34;
Front Camera Two document statistics processor 58. Same as mentioned above for Front Camera One document statistics processor 57 but for Front Camera Two;
Rear Camera One document statistics processor 59. Same as mentioned above for Front Camera One document statistics processor 57 but for Rear Camera One.
Rear Camera Two document statistics processor 60. Same as mentioned above for Front Camera One document statistics processor 57 but for Rear Camera Two;
Memory initialization processor 45. Same as mentioned for the first junction 40;
Host Processor 37. Same as mentioned for the first junction 40;
Provisions for an internal Processor 46 for future development. Same as mentioned for the first junction 40; and
Provisions for a second internal Processor 61 for future development. Same as mentioned for the first junction 40.

Finally, the fourth junction 62 indirectly controls the fourth target device 39 (“Memory 4”). As mentioned earlier, the host processor 37 directly controls the fourth memory 39, but it also supports requesting use of this memory 39 from the interface (not shown) between the host processor 37 and the FPGA 30. However, from the perspective of the FPGA 30, this merely causes the fourth memory 39 to appear as a “slower” memory than the other three memories 32-34. Otherwise the processing is identical. The fourth junction 62 can support thirteen (13) master devices as follows:
Front Camera One document statistics processor 57. Same as mentioned for the third junction 54;
Front Camera Two document statistics processor 58. Same as mentioned for the third junction 54;
Rear Camera One document statistics processor 59. Same as mentioned for the third junction 54;
Rear Camera Two document statistics processor 60. Same as mentioned for the third junction 54;
Front JPEG Compressor Output DMA Processor 63. Output from the front JPEG compressor chip is collected and this is the processor that writes it to the fourth memory 39;
Rear JPEG Compressor Output DMA Processor 64. Output from the rear JPEG compressor chip is collected and this is the processor that writes it to the fourth memory 39;
Front ITU T.6 Compressor Output DMA Processor 65. Output from the front ITU T.6 compressor chip is collected and this is the processor that writes it to the fourth memory 39;
Rear ITU T.6 Compressor Output DMA Processor 66. Output from the rear ITU T.6 compressor chip is collected and this is the processor that writes it to the fourth memory 39;
Front Scaler DMA Processor 55. Same as mentioned under the third junction 54. In certain situations, the reduced resolution image needs to be written directly to the fourth memory 39 so that “Processor” can have high speed access to it;
Rear Scaler DMA Processor 56. Same as mentioned under the third junction 54. In certain situations, the reduced resolution image needs to be written directly to the fourth memory 39 so that “Processor” can have high speed access to it;
Front IQF DMA Processor 67. As the images are being compressed, various image quality metrics are computed to look for image quality problems. This processor writes those metrics for images from the front compression pipeline to the fourth memory 39;
Rear IQF DMA Processor 68. Same as Front IQF DMA Processor 67 but for images from the rear compression pipeline; and
Provisions for an internal processor 46 for future development. Same as mentioned for the first junction 40.

As shown in FIG. 5, the “Full” output from the “FIFO #n” block Qn can also be brought in as an additional input to the “Arbitration (Partial)” block A. Once the “Wait” signal is asserted to a master device Mn, that master is basically blocked from any access to the target Tn. Under that condition, the arbitration logic may decide to weight more heavily towards a path that is blocked in an attempt to keep each path from a particular master available for use.

Furthermore, depending on the technology used for implementation, a FIFO may also have additional status outputs that give a more refined view of how full the FIFO is. Some examples are “Nearly Full,” “Nearly Empty,” “¼ Full,” “¾ Full” or in the most general sense simply a count of how many entries are currently in the FIFO. This signal is shown in FIG. 5, as the “Used” pin output of the “FIFO #n” block Qn that is then input to the “Arbitration (Partial)” block A. If it is given a more refined estimate of how full each individual FIFO is, the arbitration scheme can potentially make use of this information to possibly weight more heavily towards those paths that are most full.

In some applications, having this extra information about how full the FIFOs are (which would only be available when using the slave side arbitration implementation described in this invention) might provide for an improved arbitration function itself.

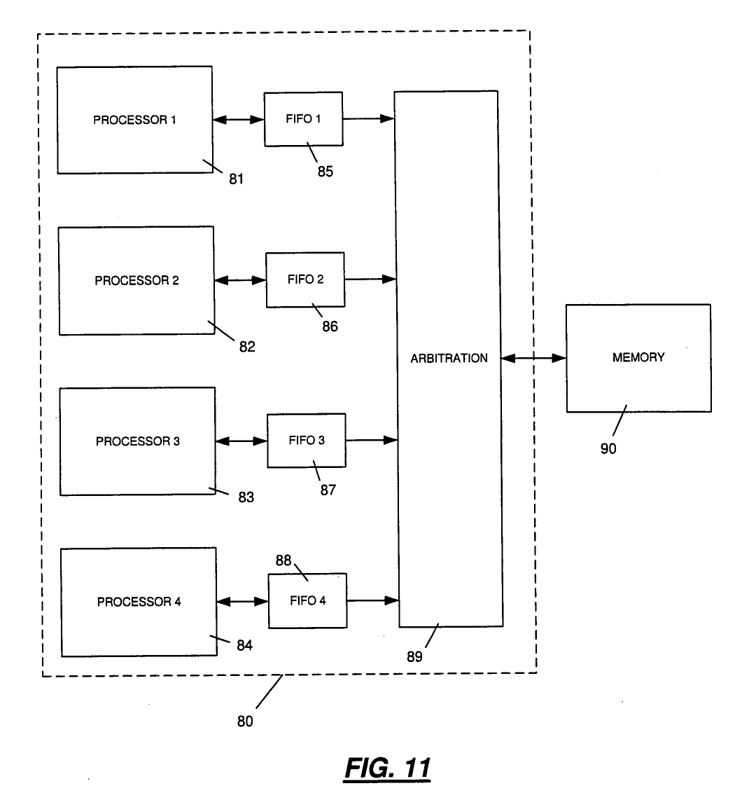

It will be appreciated that the present invention is not limited to imaging or document processing environments, but may be used in any application where multiple master devices require access to the same target. For example, an embodiment of the present invention may be readily used in a “multi-core” processor environment. As known, a “multi-core” processor is an integrated circuit in which are embedded multiple processors. Since each processor must have access to some form of external memory, exemplary architecture is shown in FIG. 11. As seen therein, processors 81-84 are individual processors, and the dashed line indicates the boundary of the so-called “multi-core” processor 80. The FIFO devices 85-88 can be embedded in the integrated circuit and connected between the processors 81-84 and the arbitrator 89, as in the other embodiments described above. Here the arbitration logic, which would typically be internal to the integrated circuit, is regulating usage of the memory interface pins of the physical device, and the memory 90 is external. Typically processors also have some form of memory internal to the device itself that may also be sharable between the processors in which case there is still arbitration logic but the memory is internal to the device.

There are of course numerous other applications and it should be readily apparent that the basic concept of multiple “master devices” needing access to a shared “target device” is a relatively common idea in the industry. Any situation where this arises there will be a need for an arbitration function that regulates usage of the shared target. Depending on the particular needs of the system and the available technology used to implement that system, one possible arbitration scheme that might be used is called slave-side arbitration. While slave-side arbitration generally will have much better performance than typical conventional bus architectures, its performance degrades as more masters are added. As the performance of the arbitration system and method of the present invention is substantially independent of the number of processors involved, the improvement of overall system performance over conventional slave-side arbitration schemes actually increases as more and more processors are added.

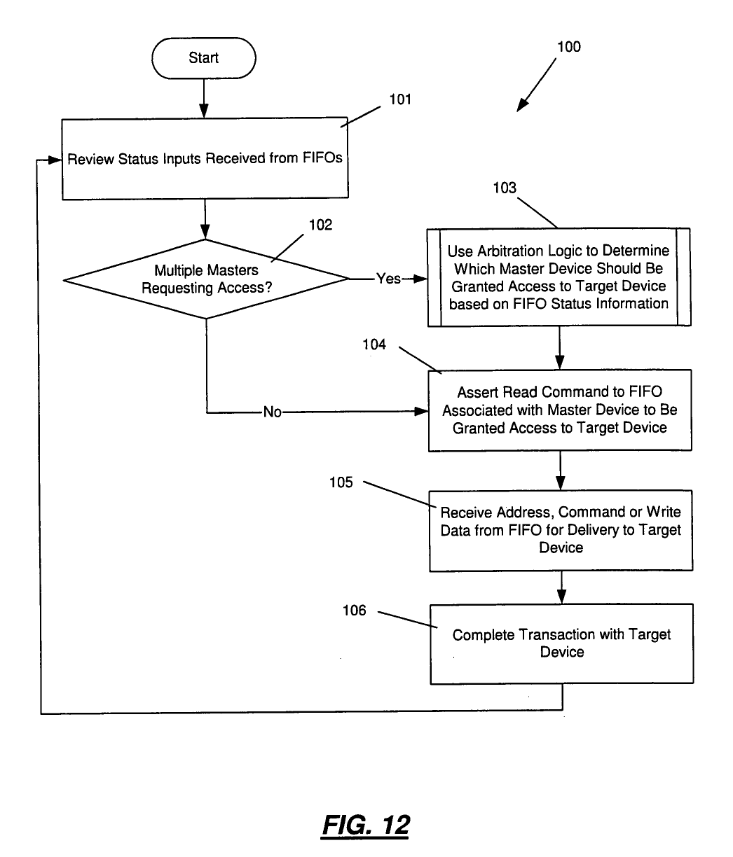

FIG. 12 is a flow diagram illustrating a process 100 for performing slave-side arbitration using FIFO buffer devices. The arbitrator receives information regarding requested access to the target device(s), such as status signals, from the FIFO devices. The status signals are reviewed by the arbitrator in step 101, and a determination is made in step 102 as to whether more than one master is requesting access to the target device. If the status signals from the FIFO devices indicate that multiple masters are requesting access to the target device, then the process moves to step 103. In step 103, arbitration logic is used to determine which master device should be granted access to the target device based on the status signals received from the FIFO devices. For example, the arbitration logic arbitrates target access based upon factors such as how many FIFO devices contain entries, priority based upon which master devices have requested access, priority based upon the type of corresponding target device(s), the number of entries contained in respective FIFO devices and/or other priorities that may be configured as desired depending upon the application.

In step 104, the arbitrator asserts a read command to the FIFO associated with the master device to be granted access to the target device. In response to the read command, the chosen FIFO device then outputs one entry in the form of address, command and/or write data from its associated master device. The data from the FIFO device is received by the arbitrator in step 105, and the transaction with the target device is completed in step 106. The process then starts over again with the arbitrator reviewing the status signals received from the FIFO devices in step 101.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically illustrated or described in detail to avoid obscuring aspects of embodiments of the present invention.

The embodiments of the present invention produce and provide systems and methods for performing slave-side arbitration using FIFO buffers, such as, for example, in an imaging system. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A system having multiple master devices that require access to a common target device, the system comprising:
a plurality of master devices including at least a first master device and a second master device;
a target device associated to the plurality of master devices, the target device being configured to fulfill transactions respectively requested by the plurality of master devices;
an arbitrator, in operative communication with the plurality of master devices and the target device, which arbitrates access to the target device in relation to the transactions respectively requested by the plurality of master devices;
a first queuing device in operative communication with the first master device and the arbitrator, the first queuing device being configured to receive transaction requests from the first master device and to communicate information regarding retained transaction requests to the arbitrator; and
a second queuing device in operative communication with the second master device and the arbitrator, the second queuing device being configured to receive transaction requests from the second master device and to communicate information regarding retained transaction requests to the arbitrator,
wherein the arbitrator arbitrates access to the target device based upon an arbitration scheme and the communicated information regarding retained transaction requests.

2. The system according to claim 1, wherein said first and second queuing devices are FIFO devices, and wherein said first FIFO device has a wait signal output that is fed back to the first master device, and said second FIFO device has a wait signal output that is fed back to the second master device.

3. The system according to claim 1, wherein the information regarding retained transaction requests comprises empty status information indicating that the queuing device is empty, and the arbitration scheme takes into account the empty status information respectively received from the first and second queuing devices.

4. The system according to claim 1, wherein the information regarding retained transaction requests comprises ready status information indicating that the queuing device has a retained transaction, and the arbitration scheme takes into account the ready status information respectively received from the first and second queuing devices.

5. The system according to claim 1, wherein the information regarding retained transaction requests comprises queue status information indicating the number of entries currently in the queuing device, and the arbitration scheme takes into account the queue status information respectively received from the first and second queuing devices.

6. The system according to claim 1, wherein the information regarding retained transaction requests comprises empty status information indicating that the queuing device is empty, ready status information indicating that the queuing device has a retained transaction, and queue status information indicating the number of entries currently in the queuing device, wherein the arbitration scheme takes into account the empty status, ready status and queue status information respectively received from the first and second queuing devices.

7. The system according to claim 1, further comprising a third master device and a third queuing device in operative communication with the third master device and the arbitrator.

8. The system according to claim 1, wherein the requested transactions are read and write operations and the arbitrator is operable to determine which of the plurality of master devices are granted access to the target device to perform read or write operations.

9. The system according to claim 8, wherein the first and second queuing devices each retain output data that comprises at least one of address, command, and write data to be passed to said target device when access is granted.

10. The system according to claim 1, wherein the first and second queuing devices are FIFO devices, and wherein the depth of each of the first and second FIFO devices is greater than a number of system clock cycles required to implement an arbitration function of the arbitrator.

11. An integrated circuit, comprising:
a plurality of processors including at least a first processor and a second processor;
a memory interface device associated to the plurality of processors, the memory interface being configured to fulfill transactions respectively requested by the plurality of processors;
an arbitrator, in operative communication with the memory interface device, which arbitrates access to the memory interface device in relation to the transactions respectively requested by the plurality of processors;
a first queuing device in operative communication with the first processor and the arbitrator, the first queuing device being configured to receive transaction requests from the first processor and to communicate information regarding retained transaction requests to the arbitrator; and
a second queuing device in operative communication with the second processor and the arbitrator, the second queuing device being configured to receive transaction requests from the second processor and to communicate information regarding retained transaction requests to the arbitrator,
wherein the arbitrator arbitrates access to the memory interface device based upon an arbitration scheme and the communicated information regarding retained transaction requests.

12. The integrated circuit according to claim 11, wherein said integrated circuit is a multi-core processor, and said first and second processors are embedded in said integrated circuit.

13. A document processing system, comprising:
a plurality of master devices including at least a first master device and a second master device;
a target device associated to the plurality of master devices, the target device being configured to fulfill transactions respectively requested by the plurality of master devices;
an arbitrator, in operative communication with the plurality of master devices and the target device, which arbitrates access to the target device in relation to the transactions respectively requested by the plurality of master devices;
a first queuing device in operative communication with the first master device and the arbitrator, the first queuing device being configured to receive transaction requests from the first master device and to communicate information regarding retained transaction requests to the arbitrator; and
a second queuing device in operative communication with the second master device and the arbitrator, the second queuing device being configured to receive transaction requests from the second master device and to communicate information regarding retained transaction requests to the arbitrator
wherein the arbitrator arbitrates access to the target device based upon an arbitration scheme and the communicated information regarding retained transaction requests.

14. The document processing system according to claim 13, wherein the first master device is an image lift device, and the second master device is a host processor device.

15. The document processing system according to claim 13, wherein the plurality of master devices respectively comprise host processor devices selected from the group consisting of: an image capture processor for storing raw camera data after detection by an image lift device, a top/bottom statistics processor for storing location of the top and bottom of each scan line of incoming video, a histogram statistics processor for storing document histogram data collected from the image lift device, a compressor input processor for reading document pixel data to be compressed, and a compressed output processor for storing compressed document data.

16. The document processing system according to claim 13, wherein the first and second queuing devices are integrated within a field-programmable gate array.

17. The document processing system according to claim 13, wherein the information regarding retained transaction requests comprises empty status information indicating that the queuing device is empty, and the arbitration scheme takes into account the empty status information respectively received from the first and second queuing devices.

18. The document processing system according to claim 13, wherein the information regarding retained transaction requests comprises ready status information indicating that the queuing device has a retained transaction, and the arbitration scheme takes into account the ready status information respectively received from the first and second queuing devices.

19. The document processing system according to claim 13, wherein the information regarding retained transaction requests comprises empty status information indicating that the queuing device is empty, ready status information indicating that the queuing device has a retained transaction, and queue status information indicating the number of entries currently in the queuing device, wherein the arbitration scheme takes into account the empty status, ready status and queue status information respectively received from the first and second queuing devices.

20. The document processing system according to claim 13, wherein the requested transactions are read and write operations and the arbitrator is operable to determine which of the plurality of master devices are granted access to the target device to perform read or write operations.

21. A method for arbitrating target system access in a system where at least one target device is configured to fulfill transactions respectively requested by a plurality of master devices including at least a first master device and a second target device, the method comprising:
receiving in a first queuing device transaction requests from the first master device and communicating information regarding retained transaction requests to an arbitrator;
receiving in a second queuing device transaction requests from the second master device and communicating information regarding retained transaction requests to the arbitrator; and
arbitrating access to the target device in relation to transactions respectively requested by the plurality of master devices based upon an arbitration scheme and the communicated information regarding retained transaction requests.

22. The method of claim 21, wherein the information regarding retained transaction requests comprises empty status information indicating that the queuing device is empty, and the arbitration scheme takes into account the empty status information respectively received from the first and second queuing devices.

23. The method of claim 21, wherein the information regarding retained transaction requests comprises ready status information indicating that the queuing device has a retained transaction, and the arbitration scheme takes into account the ready status information respectively received from the first and second queuing devices.

24. The method of claim 21, wherein the information regarding retained transaction requests comprises empty status information indicating that the queuing device is empty, ready status information indicating that the queuing device has a retained transaction, and queue status information indicating the number of entries currently in the queuing device, wherein the arbitration scheme takes into account the empty status, ready status and queue status information respectively received from the first and second queuing devices.

25. The method of claim 21, wherein the requested transactions are read and write operations and the arbitrator scheme determines which of the plurality of master devices are granted access to the target device to perform read or write operations.

26. A computer program product, for arbitrating target system access in a system where at least one target device is configured to fulfill transactions respectively requested by a plurality of master devices including at least a first master device and a second target device, the computer program product having instructions stored on a computer readable medium that when executed provide target system arbitration comprising:
receiving in a first queuing device transaction requests from the first master device and communicating information regarding retained transaction requests to an arbitrator;
receiving in a second queuing device transaction requests from the second master device and communicating information regarding retained transaction requests to the arbitrator; and
arbitrating access to the target device in relation to transactions respectively requested by the plurality of master devices based upon an arbitration scheme and the communicated information regarding retained transaction requests.

27. The computer program product of claims 26, wherein the information regarding retained transaction requests comprises empty status information indicating that the queuing device is empty, and the arbitration scheme takes into account the empty status information respectively received from the first and second queuing devices.

28. The computer program product of claim 26, wherein the information regarding retained transaction requests comprises ready status information indicating that the queuing device has a retained transaction, and the arbitration scheme takes into account the ready status information respectively received from the first and second queuing devices.

29. The computer program product of claim 26, wherein the information regarding retained transaction requests comprises empty status information indicating that the queuing device is empty, ready status information indicating that the queuing device has a retained transaction, and queue status information indicating the number of entries currently in the queuing device, wherein the arbitration scheme takes into account the empty status, ready status and queue status information respectively received from the first and second queuing devices.

30. The computer program product of claim 26, wherein the requested transactions are read and write operations and the arbitrator scheme determines which of the plurality of master devices are granted access to the target device to perform read or write operations.
